(19) United States
(12) Patent Application Publication
(10) Pub. No.: US 2008/0067163 A1
(43) Pub. Date: Mar. 20, 2008

(54) HEATED CLOTHING FOR PETS

(75) Inventors: Grigore Axinte, Bellevue, WA (US); Richard Fine, Mercer Island, WA (US); Russell Borgmann, Bellevue, WA (US); Amy Martin, Seattle, WA (US); Michael Clarke, Seattle, WA (US)

Correspondence Address: PERKINS COIE LLP;PATENT-SEA, P.O. BOX 1247, SEATTLE, WA, 98111-1247, US

(73) Assignee: HYPERION INNOVATIONS, INC., Bellevue, WA (US)

(21) Appl. No.: 11/781,060

(22) Filed: Jul. 20, 2007

Related U.S. Application Data
(60) Provisional application No. 60/807,929, filed on Jul. 20, 2006.

(51) Int. Cl. A01K 13/00

(52) U.S. Cl. 219/211; 119/850

(57) ABSTRACT

A heated clothing item for a pet is provided that includes at least one heating element for heating the surface of the clothing contacting the pet wearing the clothing. The clothing can be heated evenly throughout the portions contacting the animal so that the animal is uniformly warmed. Alternatively, the heater element can be divided into multiple sections that can be selectively energized. Multiple sections can be useful to provide heat to only a selected area of an animal as when it has an arthritic hip or some other localized ailment.

### CROSS-REFERENCE TO RELATED APPLICATION

This application claims priority to and incorporates by reference in its entirety U.S. Provisional Application No. 60/807,929 filed Jul. 20, 2006, titled “HEATED CLOTHING FOR PETS”.

### TECHNICAL FIELD

The following relates to clothing, and more particularly, clothing with a heating function for use by animals.

### BACKGROUND

Domesticated animals often receive exceptional treatment. For example, many dogs and other pets have been adorned with sweaters, raincoats, and other types of clothing. While such garments may provide insulation to retain a pet's body heat or otherwise shield the animal from rain or snow, an animal that remains stationary for an extended period in significant cold temperatures may require additional protection.

If an animal will be outdoors in severe weather conditions, a portable garment can provide heat for the animal. Conventional garments provide pockets to hold pouches of exothermically reacting substances. The pouches must be replaced every time the owner wishes to have the pet receive warmth. Moreover, the pouches only provide heat in the immediate area of the pouch. Typical electric heating pads are dangerous to use with animals because the direct contact may scald the animal's skin and the animal may chew through electrical cords.

Accordingly, it is desirable to provide improved portable heating in a comfortable garment for pets, and methods and systems for using the same.

### BRIEF DESCRIPTION OF THE DRAWINGS

Additional embodiments will be more apparent upon consideration of the following detailed description, taken in conjunction with the accompanying drawings, in which like reference characters refer to like parts throughout, and in which:

FIG. 1 is an illustration of the pet clothing on a dog according to an embodiment;

FIG. 2 provides an illustration of the clothing from FIG. 1 laid flat.

FIG. 3 is an illustration of the pet clothing on a horse according to an embodiment;

FIG. 4 illustrates an item of heated clothing worn by a dog according to an embodiment.

FIG. 5 illustrates the item of clothing from the embodiment of FIG. 4 laid out flat.

FIG. 6 illustrates the item of clothing from the embodiment of FIG. 4 laid out flat with a heating element exposed.

FIG. 7 depicts a tracing of a heating element comprised of a printable mixture including conductive materials such as silver and carbon paste, according to at least a second embodiment;

FIG. 8 depicts a cross-section of a heater assembly comprised of a printable mixture including conductive materials such as silver and carbon paste, according to at least a second embodiment;

FIG. 9 depicts an arrangement of a flexible graphite heating element according to at least one embodiment;

FIG. 10 depicts an arrangement of a flexible graphite heating element according to at least one embodiment;

FIG. 11 is a schematic of a heating circuit associated with the heated clothing according to at least one embodiment;

FIG. 12A is a schematic of a heating circuit incorporating an open loop temperature regulator for the heated clothing, according to at least one embodiment;

FIG. 12B is a circuit schematic of circuitry for use with a pulse width modulation integrated circuit for an open loop temperature regulator, according to at least one embodiment;

FIGS. 13A-C illustrate three duty cycles associated with the open loop temperature regulator shown in FIG. 12A according to at least one embodiment;

FIG. 14 is a schematic of a heating circuit associated with the heated clothing according to at least one embodiment;

FIG. 15 is a schematic of a heating circuit associated with the heated clothing according to at least one embodiment;

FIG. 16 is a schematic of a heating circuit associated with the heated clothing according to at least one embodiment;

FIG. 17 is a schematic of a heating circuit associated with the heated clothing apparatus according to at least one embodiment;

FIG. 18 is a schematic of a heating circuit associated with the heated clothing according to at least one embodiment;

FIG. 19 depicts a portable heated sleeping bag unit according to at least one embodiment;

FIG. 20 is a diagram of a microcontroller assembly for use with the heated clothing in accordance with at least one embodiment of the invention; and

### DETAILED DESCRIPTION

The following describes heated clothing for pets, and methods and systems for using the same. The details included herein are for the purpose of illustration only and should not be understood to limit the scope of the invention. Moreover, certain features that are well known in the art are not described in detail in order to avoid complication of the subject matter described herein.

A heated clothing item for a pet is provided that includes at least one heating element for heating the surface of the clothing contacting the pet wearing the clothing. In some embodiments, the clothing is heated evenly throughout the portions contacting the animal so that the animal is uniformly warmed. In other embodiments, the heater element may be divided into multiple sections that can be selectively energized. This may, for example, be useful to provide heat to only a selected area of an animal as when it has an arthritic hip or some other localized ailment. Additionally, the heating element may be included on or within the heated clothing item.

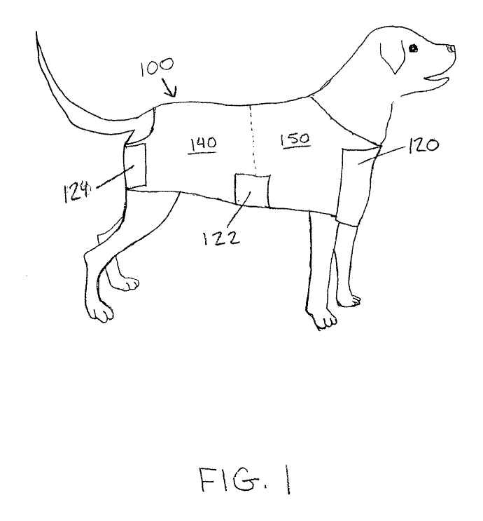

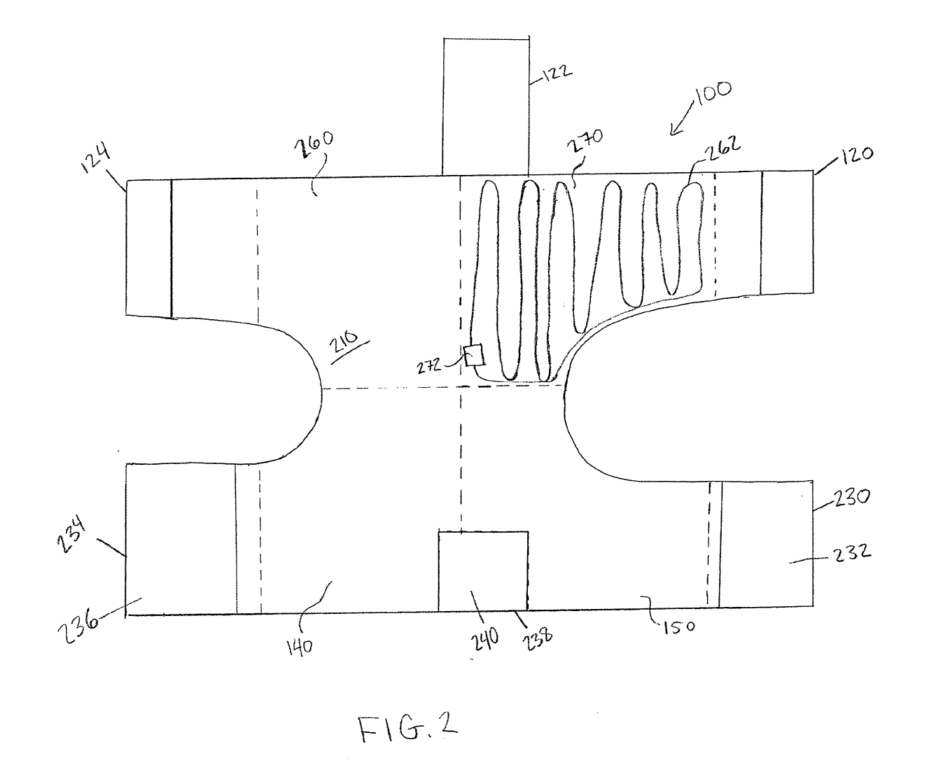

FIG. 1 provides an illustration of the clothing being worn by a dog. FIG. 2 provides an illustration of the clothing from FIG. 1 laid flat. In this embodiment, the heated article of clothing is a jacket 100 that substantially covers the torso of the animal. In some embodiments, jacket 100 is designed such that it can be reversed to expose a different pattern, design, or color. A plurality of fasteners can hold the clothing in place on the dog. The fasteners shown in FIG. 1 can include flaps 120, 122, 124 having hooks that attach to loops provided on the jacket or by other flaps. A top surface 210 of jacket 100 is shown in FIG. 2. Flap 120 can include hooks (not shown) on the bottom surface of jacket 100 that attach to loops 232 provided on top surface 210 of jacket 100 on a flap 230. Flap 124 can include hooks (not shown) on the bottom surface of jacket 100 that attach to loops 236 provided on the top surface 210 of jacket 100 on a flap 234. Flap 122 can include hooks (not shown) on the bottom surface of jacket 100 that attach to loops 240 provided on a portion 238 of top surface 210. In other embodiments, the fastener can be a zipper, buttons, straps, ties, buckles, or any other suitable type of fastener. Additionally, each flap can include a plurality of flaps. In some embodiments, jacket 100 can include fasteners at different locations suitable for maintaining jacket 100 on an animal while being convenient to secure around the animal and take off of the animal.

As illustrated in FIG. 2, jacket 100 can include quadrants 140, 150, 260, and 270 forming compartments. Jacket 100 can include more or less divisions or no divisions at all. A heating element can be provided within each quadrant. FIG. 2 illustrates a heating element 262 provided within quadrant 270.

The power source of jacket 100 may be any suitable type of power source. For example, power source may include one or more “AA” or “D” sized batteries, one or more lithium-Ion batteries, one or more nickel-metal-hydride batteries, and/or one or more other types of batteries. According to various embodiments, the batteries of power source may be rechargeable. In this case, the batteries of power source may be recharged by removing the batteries and placing them in a separate charging device, or by connecting a charger directly to the jacket 100. Moreover, portable power devices other than batteries may also be used. The batteries may be replaceable or, when rechargeable batteries are being used, the rechargeable batteries may be permanently attached to and/or enclosed by jacket 100. If an AC power device is to provide power to jacket 100, an AC/DC converter (not shown) can be used to convert from AC to DC for use by jacket 100. An AC power cord may be provided. The plug of the cord may optionally have a switch for turning the heating device on or off. When the heated pad is being powered by an AC power outlet, it can be appreciated that by configuring the heater to draw low current, a low voltage will be provided across the power cord, which will minimize harm should a pet chew through the power cord.

The power source can be provided with a control panel or switch in a single casing 272, which can be located anywhere on or within jacket 100. As illustrated in FIG. 2, casing 272 is located within quadrant 270 such that it sits on the dog's back when the dog is wearing jacket 100. This location of casing 272 is convenient for an owner to access and the location does not interfere with the dog lying down on its side. Casing 272 can be provided within jacket 100 such that the power source is mounted on the back, side, or other position on the animal that allows the animal to carry casing 272 without discomfort or interference with routine activities, such as walking. The power source and control panel may be provided separately without a casing. Alternatively, the power source and control panel can include individual casings. Jacket 100 can include a pouch or pocket for retaining the power source, control panel, and/or casing.

Top surface 210 of jacket 100 may include a zipper (not shown) or other closure adjacent casing 272 when casing 272 is located within jacket 100 so that a user may access casing 272 by unzipping the zipper and may put casing 272 away by closing the zipper. The power source can be electrically connected to heating element 262 to provide power to heating element 262. The control panel can be electrically connected to the heating element 262 to allow a user to control the power provided to heating element 262. When more than one quadrant includes a heating element, a control panel may be attached to each heating element or a single control for all of the quadrants may be provided. The user may have the ability to only turn on one, two, three, or all four heating elements at a time. By including multiple heating elements within different quadrants, the user may target a certain area of the animal to receive heat therapy. For instance, the animal may have a sore shoulder that requires heat.

In embodiments where there are no divisions and a heating element is provided uniformly throughout the clothing, a single control panel can be provided. The control panel can include one switch, knob, or button for turning the heating element on or off or adjusting the power to low, medium, or high. Alternatively, the control panel can include an on/off button, switch, or knob that is separate from the button switch, or knob controlling the power output. In other embodiments discussed below, the control panel may include a thermostat or timer.

Regarding FIG. 2, heating element 262 is shown as a carbon fiber heating element attached in a loose serpentine figure. However, heating element 262 may also include smaller, densely stitched threads or wires of carbon fiber. Additionally, heating element may be a carbon fiber powder or a mat of short carbon fibers that can be bordered with copper wires. Heating element 262 may also include any of the heating elements discussed below with respect to FIGS. 8-10. Moreover, the carbon fiber heating elements described above may be used in combination with any of the embodiments of this application.

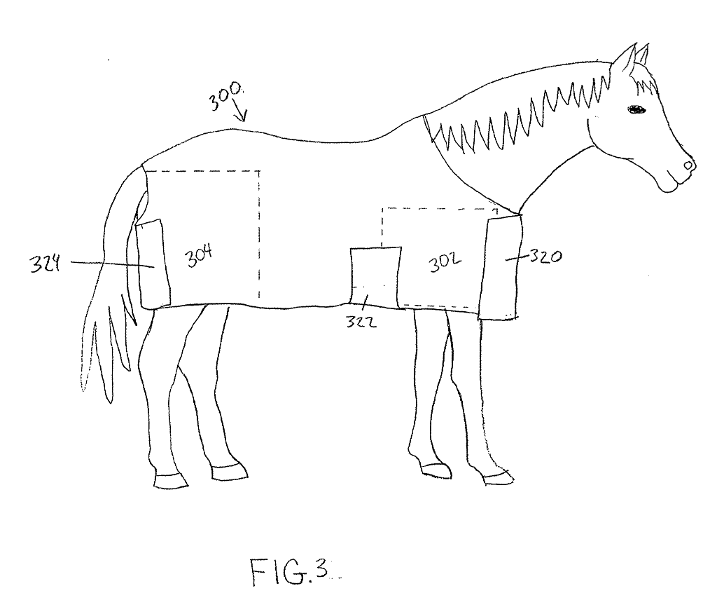

FIG. 3 illustrates heated clothing being worn by a horse. The clothing, which appears as a horse blanket 300 in FIG. 3, may be constructed with different dimensions to conform to the shape of horse. Horse blanket 300 is shown with two divisions 302 and 304 forming compartments, which can each include a heating element (not shown). Division 302 contacts the horse's shoulder and division 304 contacts the horse's hip. Two divisions identical to divisions 302 and 304 can be included on the opposite side of the horse such that the divisions contact the horse's other shoulder and hip. The location of the heating elements allows heat to target particular joints or muscles of the horse that may require heat therapy. Horse blanket 300 may include more or less divisions of any size depending upon the purpose of the heating. Additionally, horse blanket 300 can include quadrants similar to jacket 100 or horse blanket 300 can be uniformly heated without any divisions. The power source and control panel for the heating element in the horse blanket can be the same as the embodiments of the power source and control panel discussed above in relation to the dog jacket. Flaps 320, 322, and 324 can be identical to the embodiments discussed above in relation to the dog jacket. Horse blanket 300 may be open around the horse's rear and may include straps around the horse's hind legs. Additionally, horse blanket 300 may include crisscrossing beneath the horse's belly.

The heated pet clothing can be made from materials suitable for pet duty. For instance, the material can be a nylon or similar material that is well suited for protecting the internal components from moisture. Preferably, the material will be resilient to the wear and tear to which an animal will subject it, clear easily, and provide some measure of insulation to retain both the body heat of the animal and the heat generated by the heated clothing. The material can be antibacterial, stain resistant (TEFLON), chew resistant, and/or anti flea. In some embodiments, at least a portion of the material may include elasticity so that it can stretch to fit the animal snugly. In other embodiments, the material can include multiple layers of different types of materials. For instance, the outer layer of clothing can be nylon while the inner layer of clothing, which contacts the animal, can be fleece. It is contemplated that the material between the heating element and the animal protects the animal from being scalded by the heat. The material can be a flame retardant material. Additionally, according to various embodiments, the clothing may include a removable cover that may be machine or hand washable.

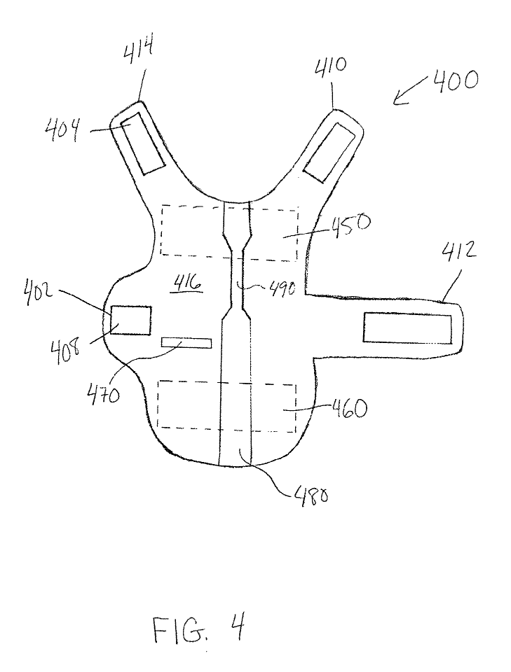

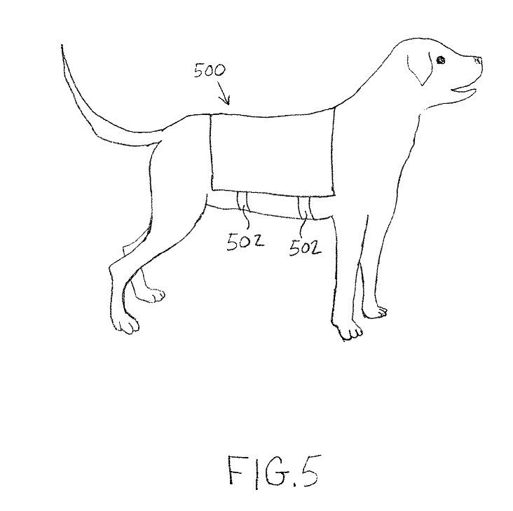

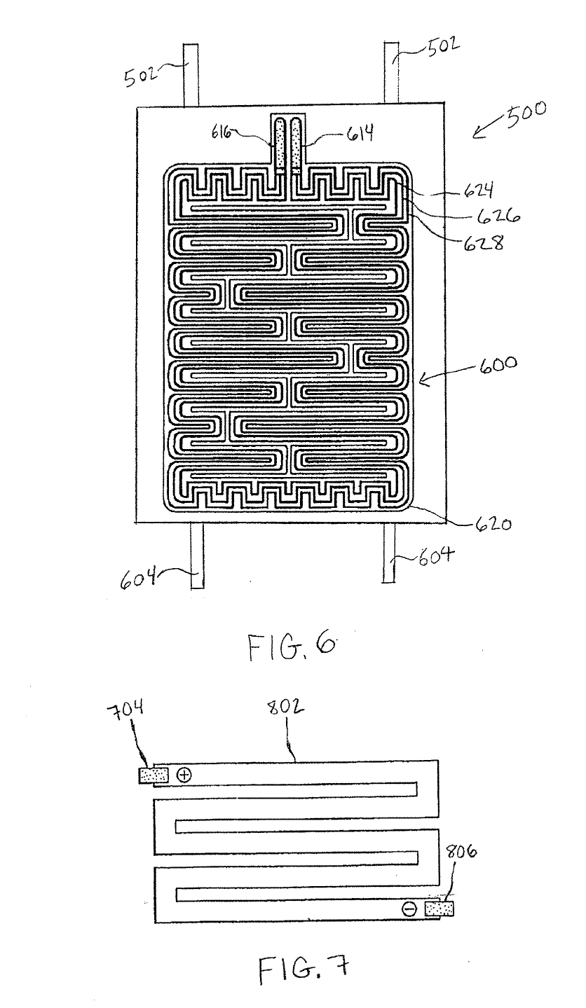

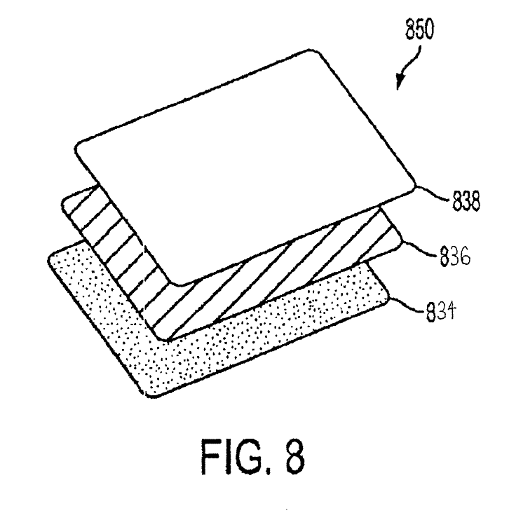

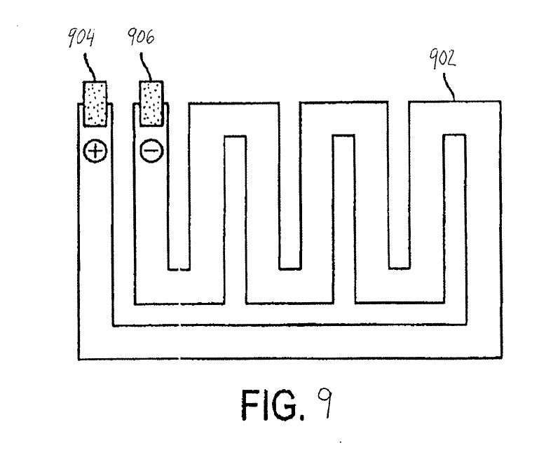

FIG. 4 illustrates an embodiment of heated pet clothing laid out flat. In this embodiment, the heated article of clothing is a jacket 400 that is worn over the torso of the animal. Jacket 400 can include a top surface 416 and flaps 410, 412, and 414. Flap 410 can include hooks (not shown) on the bottom surface of jacket 400 that attach to loops 404 provided on top surface 416 of jacket 400 on a flap 414. Flap 412 can include hooks (not shown) on the bottom surface of jacket 400 that attach to loops 408 provided on a portion 402 of top surface 416. In other embodiments, the fastener can be a zipper, buttons, straps, ties, buckles, or any other suitable type of fastener. Additionally, each flap can include a plurality of flaps. In some embodiments, jacket 400 can include fasteners at different locations suitable for maintaining jacket 400 on an animal while being convenient to secure around the animal and take off of the animal. Jacket 400 can include two heaters 450 and 460, which can be used to heat an animal's joints. A pocket 470 can be included to retain a battery for powering heaters 450 and 460. Jacket 400 can include a strip 480 of material including a handle 490. The handle 490 can be used to either facilitate lifting an animal or to attach a leash to jacket 400. Additionally, handle 490 can be used to carry jacket 400 when it is not in use. In some embodiments, a leash may be directly attached to the article of clothing. Alternatively, the article of clothing may include a D-ring or other mechanism for connecting a leash to the article of clothing.

FIG. 5 illustrates an item of heated clothing worn by a dog. In this example, a jacket 500 covers a middle portion of the dog's torso. FIG. 6 illustrates jacket 500 laid out flat with a heating element 600 exposed. Jacket 500 includes straps 502, which secure to straps 604. Straps 502 can include hooks that fasten to loops of straps 604. Any other suitable type of fastener may be used. More or less straps can be provided.

Heating element 600 includes a heater assembly 620 of at least one embodiment, made of a mixture including conductive materials, such as silver and carbon paste, and having a circuitous serpentine configuration. As can be seen, the heater assembly is comprised of three silk-screen traces, 624, 626, 628, each in parallel and closely adjacent to each other. By arranging the traces in parallel, the heater will still provide a circuitous connection to provide heating capability if one or even two of the trace lines should have a break in continuity. Further, having three traces in parallel maximizes the heat distribution to be applied to the clothing. This arrangement avoids “hot spots” and “cool spots” on the clothing to provide a more comfortable environment for the user. The heating element 620 may include electrical contacts 614 and 617 on either end. As will be described below in further detail, contacts 614 and 616 may connect to output pins of a microcontroller, which controls the application of electrical power to the heater assembly.

The heating elements that are used in accordance with various embodiments are now explained in greater detail with reference to FIGS. 7-10. FIG. 7 shows one configuration of a heating element 702 for use in clothing. According to various embodiments, heating element 702 is made of a printable mixture including semiconductive materials, such as silver and carbon paste or ink, silk-screened onto a substrate. Alternatively, the heater may be made of flexible carbon or graphite material, such as flexible graphite foil. According to other embodiments, heating element 702 may be made of a flexible graphite fabric, or a flexible graphite felt, such as TDG soft graphite felt manufactured by SGL Carbon Group of Valencia, Calif. Moreover, according to various embodiments, the thickness of the flexible graphite being used is approximately ⅛ inch. Any thickness, grade, or weave of the flexible graphite heating element 702 can be used.

As shown in FIG. 7, heating element 702 may be cut into a circuitous serpentine configuration. It is noted that, according to various embodiments, the spacing of heating element 702 shown in FIG. 7 (and the spacing present in other heating elements described herein) may remain free of materials, or may include, for example, insulation material. As shown in FIG. 7, heating element 702 may include electrical contacts 704 and 706 on either end. According to various embodiments, electrical contacts 704 and 706 are formed by attaching metal plates (or similar components) to the top and bottom surfaces of either end of heating element 702. In alternate embodiments, only one of the top and bottom surfaces of either end of heating element 702 will be in contact with electrical contacts 704 and 706, respectively. Electrical contacts 704 and 706 may be made, for example, of copper or brass. Moreover, electrical contacts 704 and 706 may, for example, be pressed onto either end of heating element 702, and may be screwed or riveted thereon. Moreover, although not shown, more than one electrical contact may be used on either or both ends of heating element 702. The invention is not limited in this manner.

As described below in further detail, the heater assembly can be attached to the clothing 100 via an adhesive material. As shown in FIG. 8, a heater made of silver and carbon paste can be comprised of three components. The heater 850 is a mixture of silver and carbon paste on either a substrate, such as polyethylene terephthalate (PET), a polyester thermoplastic polymer, or on silicone. An acrylic adhesive backing 834 is provided as an opposite side, such that one side is an adhesive, and the other side is polyester film. On the polyester film, a silver carbon paste is screen printed, as 836. It is then sent through ovens and cured, and then a top layer of polyester film 838 is applied. The final product is very flexible and durable.

After the paste is printed on a substrate, the heater is die cut into shape. The gaps between bars allow freedoms of deflection so that the heater is more durable. As it is die cut, two holes for the connector are punched at the beginning and end of the traces. This allows rivets and washers to be mounted, before the backside adhesive is applied, to complete the process. Wires are later soldered to the connectors.

Unlike a conventional nichrome wire heater assembly, heaters made from conductive (e.g., silver/carbon) paste silk-screened onto a surface and from graphite fabric are flat. This is particularly beneficial for use in clothing because it can be positioned comparatively closer to the animal without being noticeable or uncomfortable during use. That is, while a user may discern an arrangement of conventional wires placed just below surface of the clothing, the flat heater assembly 850 is unnoticeable by the animal. As a result, the heater can be placed closer to the surface, without excessive padding between the heater and the external fabric coating. This allows the heater to work more efficiently, with less heat being absorbed by the padding. Further, it enables the device to heat more quickly. Additionally, because the traces are comparatively wider than a nichrome wire arrangement, the heater assembly provides a more even heat distribution. The wider traces also are less likely to break, because a small dent or nick on the trace will not necessarily break the electrical connection.

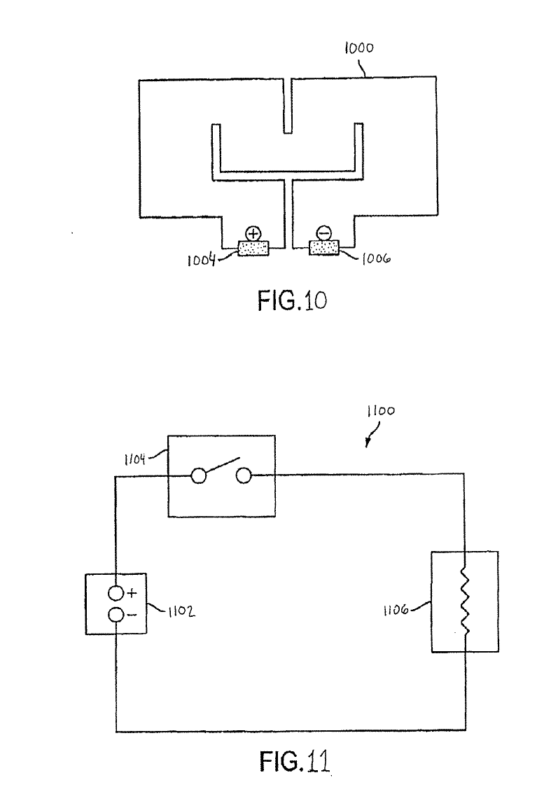

FIG. 9 shows another circuitous serpentine configuration of a flexible graphite heating element 902 with electrical contacts 904 and 906 in accordance with various embodiments. It is noted that, according to various embodiments, the use of a configuration (such as that shown in FIG. 9) in which the ends of the heating element are in close proximity to each other may be desired, e.g., to facilitate connection to the positive and negative terminals of the power source being used. FIG. 10 shows yet another configuration of a circuitous serpentine flexible graphite heating element 1002 with electrical contacts 1004 and 1006 in accordance with various embodiments, and which also includes ends that are in close proximity to each other. Other configurations are also possible.

The particular dimensions and configuration of the heating element being used (e.g., heating element 802, 902, or 1002) may be chosen (based, e.g., on calculations such as those described above) in any suitable manner such that specific desired heater resistance requirements are met. For example, for a heater made of silver and carbon tracing to sustain a battery life of several hours, batteries can be chosen to provide approximately 20 W of power, and the heater resistance can be selected to be in the range of 12 ohms, with a V initial of approximately 15.7V.

FIG. 11 shows a simplified diagram of a circuit 1100 that may be associated with heated clothing. The circuit shown in FIG. 11 includes power source 1102, on/off switch 1104, and heating element 1106. As explained above, power source 1102 may be any suitable type of power source. For instance, when the clothing is to be used in an automobile, a car adapter may be provided, in which case the power source will be the car battery or any other power source available in a car cabin. On/off switch 1104 is provided to enable a user to manually turn the heating function of the clothing being used ON and OFF. Heating element 1106 may be any suitable type of heating element in accordance with the preferred embodiments, such as carbon silver paste or a flexible graphite heating element such as explained above.

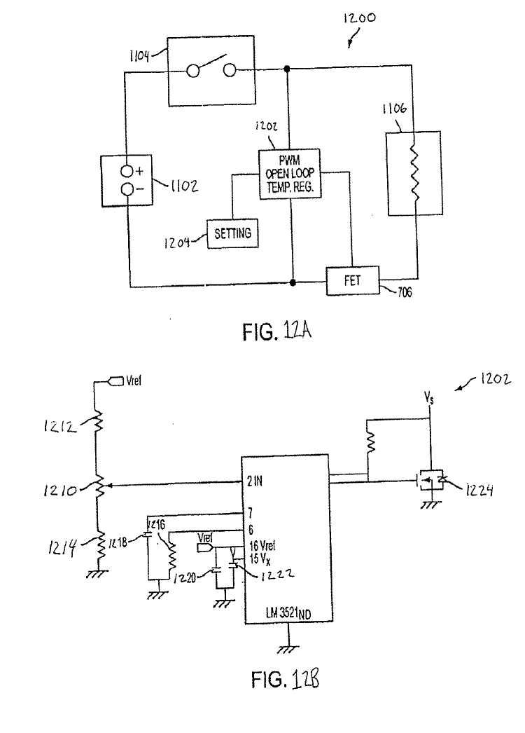

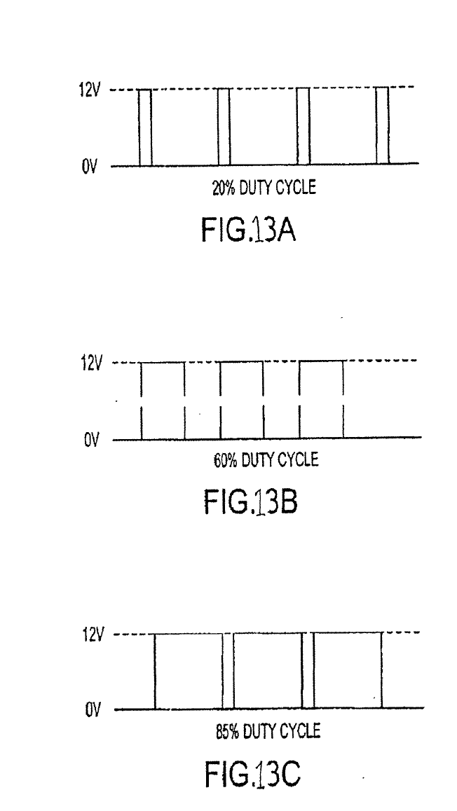

FIG. 12A shows another circuit 1200 that may be associated with the heated clothing. Circuit 1200 is similar to circuit 1100 shown in FIG. 11, but also includes an open loop temperature regulator, such as pulse-width-modulator (PWM) circuit 1202, for regulating the temperature of the heated clothing. A user may manipulate a control setting 1204 (e.g., a switch, knob, or the like) that controls field effect transistor (FET) 1206 or another suitable type of circuit device, which in turn controls the amount of time that heating element 1106 is activated. For example, FIGS. 13A-13C illustrate three possible duty cycles associated with PWM 1202, which correspond, for example, to three different settings of control setting 1204. Other duty cycles may also be implemented. Moreover, it is contemplated that, in various embodiments, control settings can be configured for a certain number of discrete settings, while in other embodiments, a substantially unlimited number of settings will be possible (e.g., using a knob rather than a switch mechanism).

FIG. 12B is a schematic diagram showing PWM circuit 1202 according to at least some of the preferred embodiments. It will be understood that, although not shown, a closed loop temperature regulator may also be used according to various embodiments. Alternatively, the circuitry can include an integrated circuit controller (microcontroller), as will be described below in further detail. In FIG. 12B, PWM circuit 1202 is National Semiconductor chip LM 3524, a dedicated PWM circuit. As inputs, the circuit includes a potentiometer 1210, which is a variable resistor that changes the voltage at pin 2 to change the duty cycle of the PWM. Resistors 1212 and 1214 provide a voltage divider from VREF for the potentiometer. Together, resistor 1216 and capacitor 1218 set the oscillation frequency. Capacitors 1220 and 1222 are used to stabilize the line. Finally, the output to FET 1224 is for turning on and off the heater in accordance with the PWM settings.

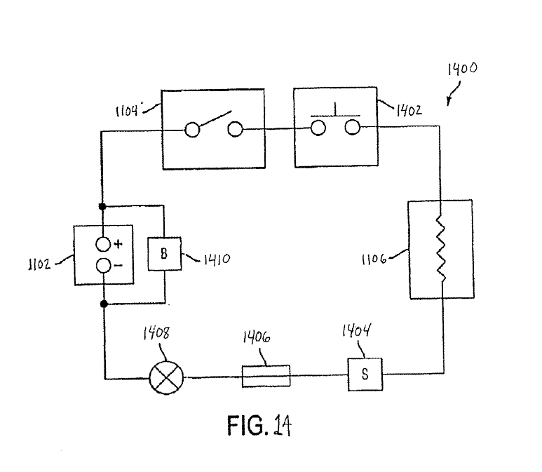

FIG. 14 shows yet another simplified circuit 1400 that may be associated with the heated clothing according to one or more embodiments. Circuit 1400 is similar to circuit 1100 shown in FIG. 11, but also includes a pressure activated push switch 1402 that may be activated by a user of the clothing. For example, assuming the user has switched on/off switch 1104 to the ON position, the circuit shown in FIG. 14 is automatically activated when the user lies down or otherwise exerts pressure on pressure switch 1402, and is automatically deactivated when the user stands or otherwise removes the exerted pressure from pressure switch 1402. In this manner, power source 1102 may be preserved by turning off the heating function when the user is not exerting pressure on pressure switch 1402. This function is useful when an animal is lying on a cold surface. Alternatively, the circuit shown in FIG. 14 can be automatically deactivated when the user lies down or otherwise exerts pressure on pressure switch 1402, and is automatically activated when the user stands or otherwise removes the exerted pressure from pressure switch 1402. In an embodiment with multiple heating elements, a pressure switch could be provided for each heating element such that pressure to each individual heating element activates or deactivates the heating element. In such case, if an animal were lying down on one side, the heating element on the side contacting the ground will deactivate while the animal is lying down, but the opposing side will remain activated. In another embodiment, pressure may cause the circuit to switch to a different duty cycle, rather than deactivate or activate.

As shown, circuit 1400 may also include a sensor switch 1404 that is designed to sense whether the heated clothing is in a position that is suitable for a user to wear, and to deactivate circuit 1400 when this is not the case. For example, assuming that on/off switch 1104 is in the ON position, and that pressure switch 1402 is either not present or pressure is somehow being exerted thereon, according to various embodiments, circuit 1400 may nonetheless be deactivated when sensor 1404 determines that the heated clothing is being transported (and thus, is not currently being used). For example, sensor 1404 may be configured to detect motion and/or angular (e.g., non-horizontal) positioning. It is noted that sensor 1404 may operate using any suitable means of detection, including, for example, a level detector or a gyroscope.

Also optionally included in circuit 1400 shown in FIG. 14 is a fuse circuit 1406. Fuse circuit may be any suitable type of fuse circuit that is capable of providing overcurrent protection. For example, fuse circuit 1406 may be designed to melt and open circuit 1400 under abnormally high electric loads. Alternatively, according to various preferred embodiments, fuse circuit 1406 will operate to only temporarily open circuit 1406. In this manner, the triggering of fuse circuit 1406 may not require servicing of the heated clothing. As also shown in FIG. 14, circuit 1400 may include an on/off indicator 1408 that lights up when the circuit is active, thereby providing the user with an indication relating to the operating status of the heated clothing. According to various embodiments, a light emitting diode (LED) may be used for this purpose, although the invention is not limited in this manner. Circuit 1400 shown in FIG. 14 also includes a cutoff circuit 1410 that is designed to deactivate power source 1102 when its power level is determined to be low (e.g., below a predetermined threshold voltage level). Although one particular configuration of cutoff circuit 1410 is shown in FIG. 14, it will be understood that other configurations are also contemplated.

While FIG. 14 illustrates that circuit 1400 can include both an on/off switch 1104 and pressure activated switch 1402, in some embodiments, on/off switch 1104 will not be present when pressure activated switch 1402 is being used. Moreover, although not shown, according to various embodiments, a bypass switch or similar mechanism maybe used to bypass (disable) any or all of pressure switch 1402, sensor switch 1404, fuse circuit 1406, on/off indicator 1408, and cutoff circuit 1410.

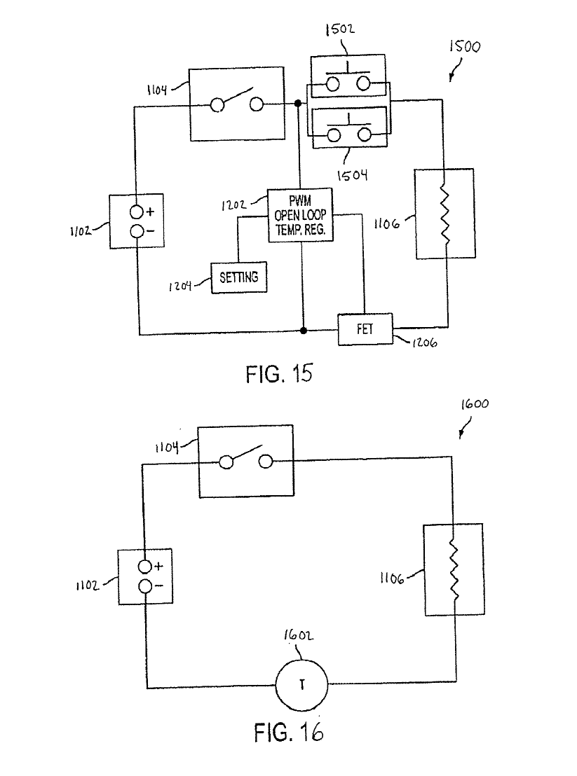

FIG. 15 shows yet another simplified circuit 1500 associated with the heated clothing according to various embodiments. Circuit 1500 is similar to circuit 1200 shown in FIG. 12A, but also includes a pair of pressure activated push switches 1502 and 1504 that may be activated by a user of the heated clothing. As shown, pressure activated switches 1502 and 1504 are placed in parallel in circuit 1500, such that when pressure is exerted on either, circuit 1500 is activated. One advantage associated with using a pair of pressure activated switches 1502 and 1504 in this manner, rather than a single pressure switch (as with circuit 1400 shown in FIG. 14), is that a user of the heated clothing will be more likely to activate at least one of switches 1502 and 1504 (especially when they are placed apart from each other) when using the heated clothing. For instance, an animal may lie down on one side of the clothing, but not the other. Moreover, according to various embodiments, more than two pressure switches may be used. For example, respective pressure switches (e.g., connected in parallel) may be placed in at four corners of the heated clothing, and also in the center, thereby further reducing the chances that circuit 1500 will not be activated when the heated clothing is in use. According to various other embodiments, when more than one pressure switch is being used, one or more of these switches may be placed in series such that pressure must be exerted on each in order for circuit 1500 to be active. This may be desirable, for example, to prevent accidental activation of circuit 1500. It is also contemplated that two or more pressure switches be placed in series at the same time that two or more pressure switches are placed in parallel. The invention is thus not limited by the number of pressure switches used, the placement (location) of these switches, or the manner in which these switches are connected (e.g., in series or in parallel).

FIG. 16 shows still another simplified circuit 1600 associated with the heated clothing according to the preferred embodiments. Circuit 1600 is similar to circuit 1200 shown in FIG. 12A, but also includes a temperature controlled switch 1602 for selectively activating and deactivating circuit 1600 based on one or more temperature readings. For example, temperature controlled switch may be associated with a thermostat (not shown) that detects the temperature at one or more points on the surface of the heated clothing. The thermostat can indicate the presence of an animal or be used to regulate the temperature of the wearing animal. When the temperature (or average temperature) is below a predetermined lower limit (e.g., 100 degrees Fahrenheit), circuit 1600 will be automatically activated by temperature controlled switch 1602. On the other hand, when the temperature (or average temperature) is above a predetermined lower limit (e.g., 110 degrees Fahrenheit), circuit 1600 may be automatically deactivated by temperature controlled switch 1602. In this manner, the temperature of the heated clothing can be automatically controlled based on real-time temperature readings on its surface (or other determined locations).

Another type of sensor switch that may be utilized according to a preferred embodiment of the present invention is a vibration sensor. When the heated clothing apparatus is in use, the surface of the clothing will experience slight vibrations and movement continually while an animal is wearing the apparatus. These slight vibrations and movements will trigger a sensor to send signals to an integrated circuit microcontroller. The signal will then reset a timer circuit. If the timer circuit has not been reset within, for example, 8 minutes, the microcontroller will switch off power to the heater, and accordingly, the application of heat to the apparatus. In this manner, the vibration sensor acts in conjunction with the microcontroller to provide power save functionality to automatically turn off the heater and conserve battery power when the apparatus is not in use.

In FIG. 14, the pressure-activated switch 1402 can be replaced with a vibration switch. The vibration sensor acts as a tilt sensor/rolling ball switch, but can be used to detect vibration instead of tilt. A ball is encapsulated in a cylinder. When the cylinder is tilted it acts as a switch, such that the ball either electrically closes or opens the circuit depending on where the ball is. In normal operation for the clothing in the at least one embodiment, the ball is on the sensor. Any slight vibration causes the ball inside to momentarily jump off the sensor, creating a signal to the microcontroller. A suitable vibration switch is provided by Yusan Electronic Co. Ltd., as the SW-200 Series.

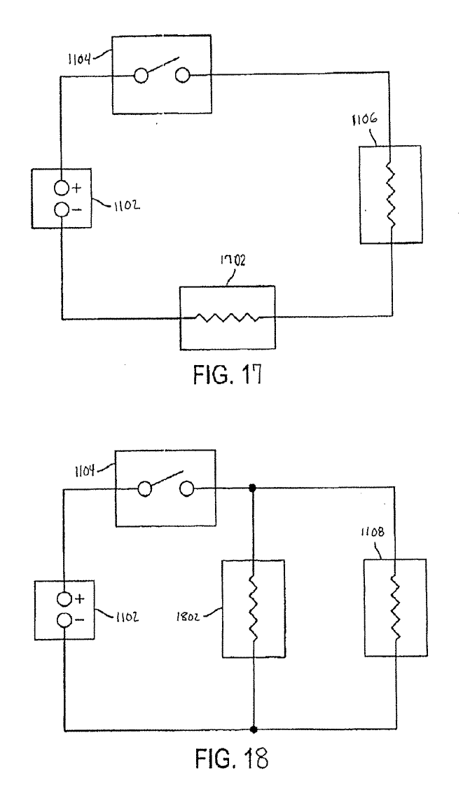

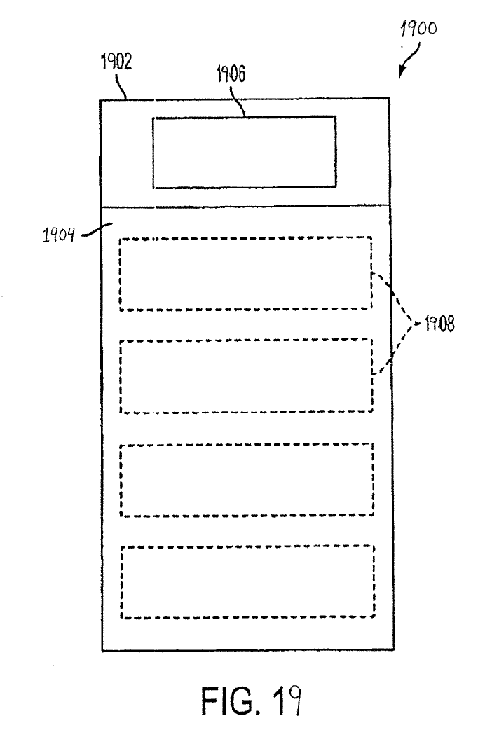

According to FIG. 17, a circuit may be used that is substantially similar to circuit 1600 shown in FIG. 16, but also includes a second heating element 1702 connected in series with heating element 1106. According to various other embodiments, as shown in FIG. 18, a second heating element 1802 being used for backrest portion 1204 may be connected in parallel with heating element 1108.

According to at least one embodiment of the present invention, the clothing includes an integrated circuit microprocessor or control that receives signals from a user interface panel and controls the application of power to the heater assembly for generating heat to the surface. In at least one embodiment, the user interface includes a switch, knob, or push button that enables a user to select three power levels, or heat settings. These power levels correspond to high, medium, and low power levels, which in turn cause the pulse-width modulator (PWM) to apply comparatively more heat or less heat. As can be appreciated, a higher power level may be selected by a user when the clothing is used in an environment that is very cold, whereas a lower power level may be selected when the environment is not perceived as being quite as cold. Since, in various embodiments, the clothing is powered by a battery pack, the use of a comparatively lower power level results in less power being used, which conserves battery power. Thus, if a user wishes to use the clothing with the battery pack for several hours, the user may select a lower power level so that the clothing will continue to provide heat for a comparatively longer period of time. Although in various embodiments three power levels are provided, it can be appreciated that more or less power levels can be provided without detracting from features of the invention.

By incorporating capability for selecting between three distinct power levels, the user also is able to adjust how quickly the clothing reaches a desired temperature range to provide comfort for the user. In at least one embodiment, the highest heat setting can be used as an initial heat ramp until the desired temperature is reached. At that point, the user will then adjust the heat setting by selecting one of the two other high/low settings. Thus, by adjusting the power levels between higher and lower settings, a user is able to operate the clothing so as to heat up more quickly than if only one or two power levels were provided.

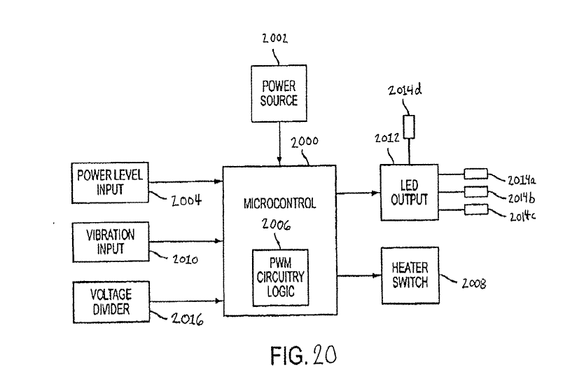

FIG. 20 illustrates an integrated circuit microcontroller assembly in accordance with at least one embodiment of the present invention. As can be seen, microcontroller 2000 receives DC power from power source 2002. The microcontroller 2000 can be, for example, an ELAN 78P0458, programmable general purpose 8 bit microcontroller. The power source 2002 may be a rechargeable battery pack, as described above. Alternatively, or in addition, the microcontroller 2000 may accept power inputs from a car adapter or an AC source. The microcontroller also receives a power level input 2004, which is an electrical signal input from a user interface. As illustrated and described below in further detail, the power level input preferably includes an on/off switch or button, and a button, switch, dial, or other adjuster for indicating a power level (although the these may be combined into a single button, switch, dial or knob). Based upon this input, the PWM circuitry logic 2006 programmed within microcontroller 2000 determines a PWM duty cycle, which is used to turn on and off the heater switch 2008 for applying power or disconnecting power from the heater.

In at least one embodiment, the microcontroller sends one or more signals to a panel printed circuit board assembly to trigger a display on the user interface. The main power switch or button may be a lighted switch/button to provide visual confirmation to the user that the clothing is operating. Likewise, the power level switch/button may be lighted to provide a visual indication to the user concerning the power level at which the apparatus is operating. Alternatively, the switches/buttons trigger one or more LEDs that are separate from the switches/buttons themselves, to provide a visual indication of the selected power level. For an indication of power levels, multiple LEDs may be provided. In the at least one embodiment having three power levels, three LEDs will be illuminated when the highest power setting is selected, two LEDs will be illuminated when the medium power setting is selected, and a single LED is illuminated for the lowest power setting. The microcontroller receives a user's power level selection from the power level button as a signal from a circuit board associated with the user interface. Again, based on the user's power setting, a PWM circuit determines the appropriate duty cycle, and the microcontroller sends power to the heater in accordance with the selected duty cycle. The PWM circuitry can be in a separate microcontroller, such as that shown and described with reference to FIG. 12B, or in a general microcontroller that can also provide control of other features, such as lighting, powersave, and low battery cutoff, as will now be described.

Referring back to FIG. 20, microcontroller 2000 provides one or more electrical signals to LED output(s) 2012 to provide an indication to the user whether the clothing is in operation. In one embodiment, when the microcontroller 2000 receives input from power level input 2004 indicating that the clothing is powered on, at least a first LED 2014d is illuminated. Depending upon the power level that is selected at power level input 2004, one or more of the LEDs 2014a, 2014b, and 2014c are illuminated from LED output 2012. In a preferred embodiment, capability is provided for three power levels, and each of three LEDs receives a signal from a separate pin on microcontroller 2000.

Microcontroller 2000 additionally receives an electrical signal from a vibration input 2010. As described above, in at least one embodiment, a vibration sensor sends an electrical signal whenever the clothing is powered on and a vibration is experienced, which temporarily moves a ball from atop the sensor. The microcontroller 2000 uses this electrical signal to reset a counter, which times out if no vibration is experienced within a predetermined amount of time. If the timeout circuit within microcontroller 2000 expires, it is determined that the clothing is not in use, and it enters a powersave state, whereby the heater switch is turned off such that no power is supplied to the heater, and the LEDs 2014a-d are turned off to signal to the user that the clothing is not providing heat.

Microcontroller 2000 also receives input from voltage divider 2016. This is used to detect when the battery source has reached a critically low battery level. The voltage divider provides an analog voltage signal that is based upon the battery voltage level VREF. This level is then supplied to an analog to digital converter input pin in the microcontroller 2000, which then converts the signal into a digital value. If the digital value falls below a threshold value stored in microcontroller memory, the firmware executes a routine to turn off the heater supply 2008 and to send a blinking signal to LED output 2012 to indicate to the user that the battery must be re-charged. In at least one embodiment, when the firmware enters this state, all three LEDs begin blinking. This circuitry prevents overdischarging, which may prematurely cause the battery to become permanently discharged.

It is understood that the different types of heating elements and control systems for the heating elements described above may be used in any combination with any of the embodiments discussed above. Although the examples shown include a dog and a horse wearing heated pet clothing, the heated pet clothing may be used by any time of animal. For instance, the heated pet clothing can be worn by a cat.

Other embodiments, extensions, and modifications of the ideas presented above are comprehended and should be within the reach of one versed in the art upon reviewing the present disclosure. The scope of the present invention in its various aspects should not be limited by the examples presented above. The individual aspects of the present invention, and the entirety of the invention should be regarded so as to allow for such design modifications within the scope of the present disclosure.

1. A heated clothing item for providing a pet with heat therapy comprising:
an article of clothing adapted to be worn by an animal;
a heating element on or within the article of clothing for generating heat from an electrical current, structured to provide heat to a joint of the animal wearing the article of clothing; and
a battery on or within the article of clothing for powering the heating element.

2. The heated clothing item of claim 1, wherein the heating element comprises carbon fiber.

3. The heated clothing item of claim 2, wherein the heating element includes wires comprised of carbon fiber.

4. The heated clothing item of claim 2, wherein the heating element includes powder comprised of carbon fiber.

5. The heated clothing item of claim 1, further comprising a timer circuit for automatically turning off the heating element after a predetermined amount of time.

6. The heated clothing item of claim 1, wherein the heating element comprises a flexible, semiconductive material.

7. The heated clothing item of claim 1, further comprising a second heating element, wherein when an animal is wearing the article of clothing the second heating element can provide heat to a joint of an animal.

8. The heated clothing item of claim 1, further comprising a vibration sensor for detecting the presence of an animal wearing the article of clothing, wherein the heating element is activated when an animal is detected and the heating element is deactivated when an animal is no longer detected.

9. A heated clothing item for providing heat to a pet comprising:
an article of clothing adapted to be worn by an animal;
a plurality of fasteners for removably placing the article of clothing on an animal, a heating element on or within the article of clothing for generating heat from an electrical current;
a battery on or within the article of clothing for powering the heating element; and
a control for controlling the temperature of the heating element.

10. The heated clothing item of claim 9, wherein the heating element comprises carbon fiber.

11. The heated clothing item of claim 9, further comprising a timer circuit for automatically turning off the heating element after a predetermined amount of time.

12. The heated clothing item of claim 9, wherein the heating element includes powder comprised of carbon fiber.

13. The heated clothing item of claim 9, further comprising a handle for facilitating lifting the animal or attaching a leash to the article of clothing.

14. A heated clothing item for a pet comprising:
an article of clothing adapted to be worn by an animal;
a flexible, semiconductive heating element on or within the article of clothing; and
a control panel on or within the article of clothing for controlling the heating element.

15. The heated clothing item of claim 14, further comprising a second flexible, semiconductive heating element, wherein the first and second heating elements provide heat to different areas on an animal adorning the article of clothing.

16. The heated clothing item of claim 14, further comprising a battery on or within the article of clothing for powering the heating element.

17. The heated clothing item of claim 14, further comprising a handle for facilitating lifting the animal or attaching a leash to the article of clothing.

18. The heated clothing item of claim 14, further comprising a thermostat.

19. The heated clothing item of claim 14, further comprising a control for controlling the temperature of the heating element.

20. The heated clothing item of claim 14, further comprising a timer circuit for automatically turning off the heating element after a predetermined amount of time.
